(19) United States
(12) Patent Application Publication
(10) Pub. No.: US 2003/0204811 A1
(43) Pub. Date: Oct. 30, 2003

(54) Website system and method with dynamic maintaining function

(76) Inventors: Xi-Nam Dam, Dalian (CN); Hong-Wei Bi, Dalian (CN); Wang-Yang Du, Dalian (CN)

Correspondence Address: BIRCH STEWART KOLASCH & BIRCH, PO BOX 747, FALLS CHURCH, VA, 22040-0747, US

(21) Appl. No.: 10/279,103

(22) Filed: Oct. 24, 2002

(30) Foreign Application Priority Data
Apr. 24, 2002 (TW) 91108414

(51) Int. Cl. G09G 5/00

(52) U.S. Cl. 715/500

(57) ABSTRACT

A website system and method with dynamic maintaining function are disclosed. The user uses a browser to connect with the disclosed system through a network. The tree structure is employed to present the website structure in the browser. The web page editing is displayed in the what-you-see-is-what-you-get (WYSIWYG) fashion, so that the user can perform dynamic editing on the website contents. The disclosed further perform real-time processing, storage, and transmissions.

### BACKGROUND OF THE INVENTION

1. Field of Invention

The invention relates to a network application service system and the method thereof. More explicitly, the invention relates to a system that enables a user to perform website contents editing within a browser and to perform real-time maintenance and the method thereof.

2. Related Art

As the Internet uses grow, the number of websites also increases exponentially. Accordingly, the website contents maintenance also becomes important and a routine job.

In the past, the website contents maintenance is usually done by professional technicians using special utilities. After the editing, the finished website contents are moved a server that provide services. However, this method complicates the maintenance routine and wastes a lot of time. To accomplish the job of website maintenance, the user usually has to possess vairous kinds of professional skills. It is therefore almost impossible for those without any technical computer knowledge to do the job. This inevitably forms a high threshold and big obstacle in performing such tasks. Most important of all, this method separates the website contents maintenance and website contents execution. Therefore, the user cannot simultaneously maintain the website contents and understand what are the possible effects produced by the website contents. It is often the case that the final result is different from what the maintenance technician expects. As a result, the user has to repeat over and over again the website contents editing and corrections. This increases the maintenance time and thus lowers the efficiency of website contents maintenance.

As more advanced hardware and software technologies become available, it is an important issue to find a way to fully utilize the convenience of network systems and related hardware and software techniques so that the website contents maintenance procedure can be simplified. It is highly desirable to have a system such that the user does not need to know too much technical details while being able to easily perform website contents maintenance. The system should be able to provide a dynamic editing and real-time updating environment.

### SUMMARY OF THE INVENTION

In view of the foregoing, the invention provides a website system and method with dynamic maintaining function. An objective of the invention is to simplify the website content maintenance procedure. The user only needs to establish connection with the disclosed system through a browser in order to perform website contents maintenance. The system further process, store, and send the edited website contents in real time.

Another objective of the invention is to use a special editing display method to present the website structure using the tree structure within a browser and the website contents in the WYSIWYG fashion. Therefore, the user can perform website contents maintenance in a more convenient and efficient way.

To achieve the above-mentioned objectives, the disclosed website system with dynamic maintaining function includes: a website contents database, an extraction and storage module, a transmission and reception module, and an editing module.

The disclosed method includes the steps of: establishing connection to enter the dynamic website maintenance system; the user's selecting website contents and extracting and returning the selected website contents for display; displaying user's selected website content items for dynamic maintenance operations; receiving dynamic maintenance contents, performing editing operations and generating new website contents; and storing and returning the website contents and displaying them.

### BRIEF DESCRIPTION OF THE DRAWINGS

The invention will become more fully understood from the detailed description given hereinbelow illustration only, and thus are not limitative of the present invention, and wherein:

FIG. 1 shows the structure of the website system with dynamic maintaining function and the corresponding method according to the invention;

FIG. 2 is a flowchart of the disclosed website system and method with dynamic maintaining function;

FIG. 3-a is a schematic view of dynamic maintainence of a webpage according to the invention;

FIG. 3-b is another schematic view of dynamic maintainence of a webpage according to the invention;

FIG. 4-a is a schematic view of dynamic maintainence of a webpage according to the invention; and

FIG. 4-b is another schematic view of dynamic maintenance of a web page according to the invention.

### DETAILED DESCRIPTION OF THE INVENTION

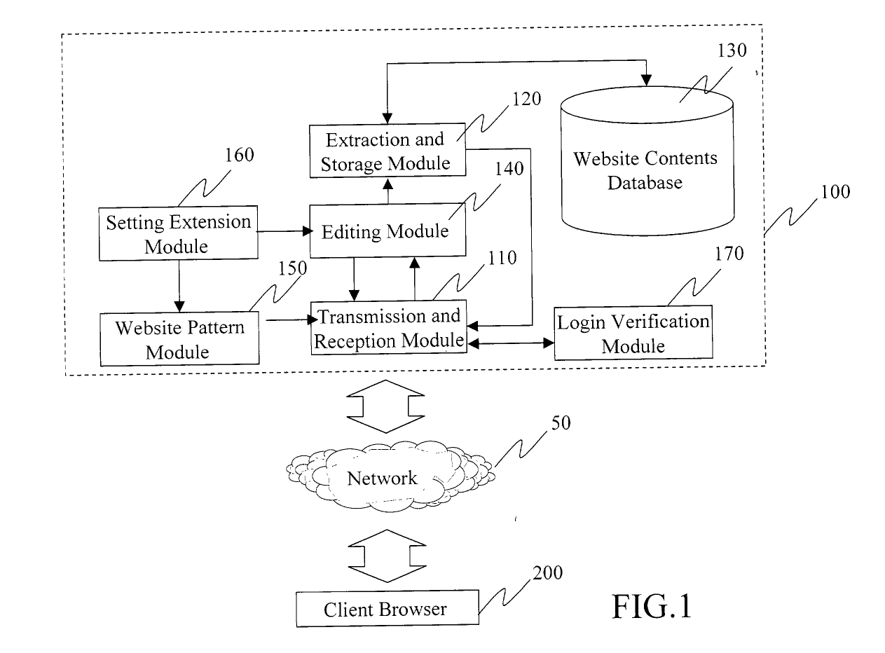

The disclosed website system and method with dynamic maintaining function provides a user to use a client browser 200 to connect to the dynamic website maintenance system 100 through a network 50 for maintaining website contents. With reference to FIG. 1, the system 100 contains a transmission and reception module 110, an extraction and storage module 120, a website contents database 130, and an editing module 140.

(1) The transmission and reception module 110 receives a user request sent from the client browser 200 and responds to the request. It further provides website contents (including website structure, webpage contents, etc), performs a login verification procedure (through a login verification module 170 according to a user name and a corresponding password), and transmits edited website contents and website patterns (including website structure patterns and webpage patterns).

(2) The extraction and storage module 120 extracts original website contents from the website contents database 130 according to the user's request. It further stores website contents edited by the user and processed by the system back to the website contents database 130 during the dynamic website maintenance process.

(3) The website contents database 130 stores all website contents, including all website structures and the corresponding webpage contents. The database 130 can store multimedia contents such as texts, pictures, animations, and voices.

(4) The editing module 140 receives dynamic maintenance contents transmitted from the client browser 200 and processes the program code corresponding to the website contents (including adding, deleting and modifying). The newly generated website contents through such edition are sent back to the client browser 200 for the user's review and subsequent maintenance procedures. If the dynamic maintenance contents edited by the user are simultaneously stored in different website structures and webpage contents, then the editing module 140 performs the same editorial operations on such objects. Therefore, the user can update all the same website contents on the web by simply executing a single dynamic maintenance action.

In fact, in order for the user to readily maintain a website, the disclosed dynamic website maintenance system 100 further has a website pattern module 150 that provides varied website structure patterns and webpage patterns for user's selection. To make the system more flexible so that the user can make adjustments at his or her will, the system 100 further has a setting extension module 160. The user can update the website patterns in the website pattern module 150 at any time and perform adjustments and settings on the editing rules in the editing module 140. Moreover, in order to provide complete website maintenance functions, the disclosed dynamic website maintenance system 100 allows the user to preview the result during the dynamic maintenance procedure and provides the function of directly sending website contents.

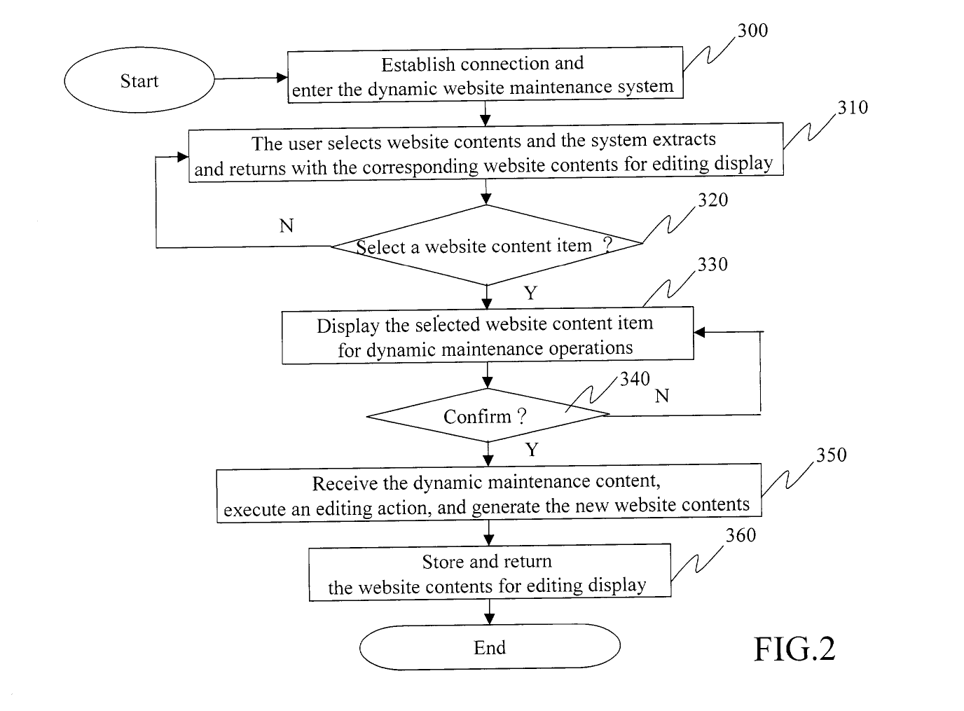

Please refer to FIG. 2 for the procedure of the disclosed system and method. First, the user enters a login procedure through a client browser 200. After verifying the user name and the password, the connection between the client browser 200 and the dynamic website maintenance system 100 is established and the user enters the system 100 (step 300). The user selects website contents to be dynamically maintained. After the system receives the selection request, it extracts the corresponding website contents from the website contents database 130 and return them to the client browser 200 for editing display. The editing display presents the website organization in the tree structure. The webpage contents are displayed in the so-called “what-you-see-is-what-you-get” (WYSIWYG) fashion (step 310). The system then determines whether the user selects one of the website content items in the website structure (step 320). If not, the system stays in step 310 to continue displaying the website contents. Otherwise, it means the user wants to perform dynamic maintenance operations on the selected website content (including adding, deleting or modifying the website structure and webpage content). The system then displays the webpage contents in the website for the user to start various dynamic maintenance operations (step 330). During the dynamic maintenance process, the system determines whether the user executes a confirmation action (step 340). If there is no confirmation, then the system allows the user to continue editing and maintaining. Otherwise, it means that the user has finished the dynamic maintenance operation. The system then receives the dynamically maintained contents by the user and immediately processes editing actions, adding, modifying or deleting the program code corresponding to the webpage contents and generating new website contents (step 350). If the contents being maintained by the user exist in many different webpage contents and website structures, the system performs same editing actions on all the same website structures and webpage contents. Thus, the user can simultaneously update all the corresponding website contents by a single dynamic maintenance action. Finally, the processed new website contents are sent back to the client browser 200 for display in the same fashion as described before. This finishes the dynamic website maintenance procedure (step 360).

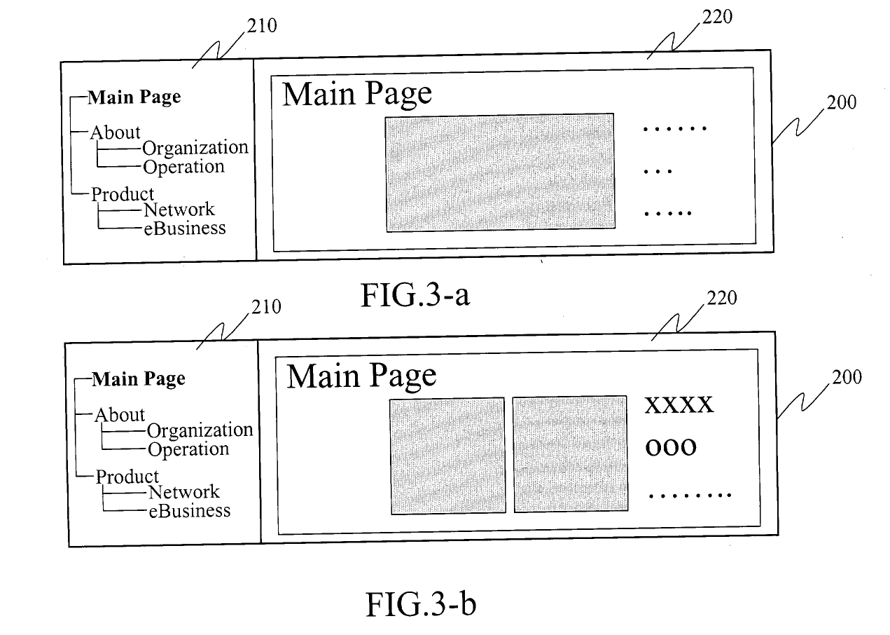

We use embodiments shown in FIGS. 3-a, 3-b, 4-a, and 4-b to demonstrate the feasibility of the invention. With reference to FIGS. 3-a and 3-b, when the disclosed dynamic website maintenance system 100 returns the website contents selected by the user, they are displayed in the client browser 200. The website structure is shown in the website structure display area 210 using the tree structure. The webpage contents display area 220 presents the webpage contents in the WYSIWYG fashion. If the user wants to perform dynamic maintenance on the homepage of the website, he or she only needs to click the homepage in the tree structure. The system displays the webpage contents corresponding to the homepage (as shown in FIG. 3-a). The user can then start the dynamic maintenance operation. After user's confirmation and being processed by the system, the newly generated webpage contents are sent back and the user can immediately see the dynamic maintenance result (see FIG. 3-b). This then concludes the dynamic maintenance procedure for webpage contents.

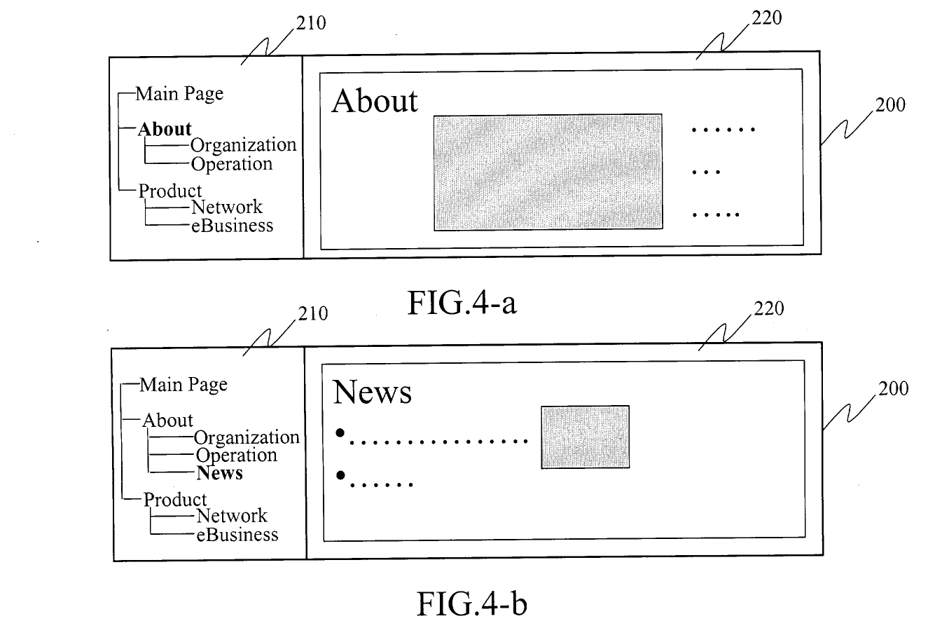

With reference to FIGS. 4-a and 4-b, if the user wants to add a website content item (using “ [symbol] ”) under “ [symbol] ” in the original website structure (FIG. 4-a), the user only needs to click “About” in the tree structure to perform the dynamic maintenance operation of adding a new website structure. After user's confirmation, the user can immediately see the maintenance result from the website structure display area 210 (FIG. 4-b). The system further allows the user to maintain the website contents of “ [symbol] ” This then finishes the dynamic maintenance procedure for website structure.

### EFFECTS OF THE INVENTION

The disclosed website system and method with dynamic maintaining function allow the user to perform various dynamic maintenance operations on website contents simply through a browser. The user does not need to know very technical computer knowledge and nor will he or she waste time in a complicated editing procedure.

The disclosed system can generate new maintenance result through a real-time editing procedure according to the website maintenance contents edited by the user. The user can therefore learn the dynamic updating condition during the maintenance operation. The user can simultaneously update all website contents though the real-time editing function of the disclosed system by simply performing a single dynamic maintenance action.

Furthermore, the website structure is presented through special editing display in a browser using the tree structure. The web page contents are presented in the WYSIWYG fashion. The user is thus able to quickly understand the website contents.

What is claimed is:

1. A website system with dynamic maintaining function for a user to establish connection using a browser to perform dynamic editing and real-time updating of a website, the system comprising:
a website contents database, which stores a website content;
an extraction and storage module, which extracts and stores the website content selected to be maintained by the user;
a transmission and reception module, which receives a user request to provide the website content, a login verification procedure, edited website content items, and a website pattern; and
an editing module, which edits the program code corresponding to the website content according to a dynamic maintenance operation and generates the processed website content items.

2. The system of claim 1, wherein the website content includes a website structure and a web page content.

3. The system of claim 2, wherein the website structure is presented in the browser using a tree structure.

4. The system of claim 2, wherein the web page content is presented in the browser in the what-you-see-is-what-you-get (WYSIWYG) fashion.

5. The system of claim 1, wherein the website pattern comprises a website structure pattern and a web page pattern.

6. The system of claim 1, wherein the dynamic maintenance operation refers to addition, modification and deletion of the web page structure and the web page content.

7. The system of claim 1, wherein the editing module performs an editing process to simultaneously update all website structures and web page contents that contains the website content items being processed according to a single dynamic maintenance operation.

8. The system of claim 1, wherein the editing process refers to the addition, modification and deletion of website content items in the program code according to the maintained content.

9. The system of claim 1 further comprising a login verification module, which provides a login verification procedure for the user to enter a user name and a password.

10. The system of claim 1 further comprising a website pattern module, which provides website structure patterns and web page patterns.

11. The system of claim 1 further comprising a setting extension module, which provides website structure patterns, updates and extensions of web page patterns, and settings and adjustments of editing rules.

12. The system of claim 1 further comprising the functions of previewing and sending the website content.

13. A website method with dynamic maintaining function for a user to establish connection using a browser to perform dynamic editing and real-time updating of a website, the method comprising the steps of:
establishing connection and entering a dynamic website maintenance system;
the user's selecting a website content, extracting and returning the corresponding website content for editing display;
displaying user selected website content items for a dynamic maintenance operation;
receiving the content after the dynamic maintenance operation and performing an editing process to update the website content; and
storing and returning the website content for editing display.

14. The method of claim 13, wherein the website content includes a website structure and a web page content.

15. The method of claim 13, wherein the editing display refers to the means of presenting the website structure using a tree structure and presenting the website content in the what-you-see-is-what-you-get (WYSIWYG) fashion.

16. The method of claim 13, wherein the dynamic maintenance operation refers to addition, modification and deletion of the web page structure and the web page content.

17. The method of claim 13, wherein the step of receiving the content after the dynamic maintenance operation and performing an editing process to update the website content further comprises the step of simultaneously updating all website structures and web page contents that contains the website content items being processed according to a single dynamic maintenance operation.

18. The method of claim 13, wherein the editing process refers to the addition, modification and deletion of website content items in the program code according to the maintained content.

19. The method of claim 13 further comprising a login verification step, which provides a login verification procedure for the user to enter a user name and a password.

20. The method of claim 13 further comprising the step of providing website structure patterns and web page patterns.

21. The method of claim 13 further comprising the step of providing website structure patterns, updating and extending web page patterns, and setting and adjusting editing rules.

22. The method of claim 13 further comprising the step of previewing and sending the website content.
